(19) United States
(12) Patent Application Publication
(10) Pub. No.: US 2026/0089173 A1
(43) Pub. Date: Mar. 26, 2026

(54) SYSTEM AND METHOD FOR MATERIAL EVENT MODELING

(71) Applicant: Kovrr Risk Modeling, Ltd., Tel Aviv (IL)

(72) Inventors: John Freund, Charlotte, NC (US); Lotem Eldar, Tel Aviv (IL); Or Amir, Rishon LeZion (IL); Shai Yanovski, Tel Aviv (IL); Amir Shur, Yehuda Kami (IL)

(21) Appl. No.: 18/897,866

(22) Filed: Sep. 26, 2024

(51) Int. Cl. H04L 9/40

(52) U.S. Cl. CPC H04L 63/1416

(57) ABSTRACT

A computer-implemented method for material cyber event modeling includes: generating a cyber event catalog based on a past cyber event, the catalog including a plurality of cyber events, wherein generating catalog further includes: determining a distribution of all event parameters by extrapolating data from a past event; and assigning a set of restriction rules, wherein the parameter distribution and the set of restriction rules are used to create events in the catalog; simulating a cyber event, of the plurality of events in the catalog, to predict whether an organization is affected by a simulated cyber event, wherein the organization is an organization selected from a hazard table, and wherein the simulating cyber event simulates malicious activity; and estimating a damage of the cyber event on the organization by employing a damage function, including generating an exceedance probability (EP) curve for the cyber event, for at least one materiality category.

### TECHNICAL FIELD

The present disclosure relates generally to event modeling and, more specifically, to modeling for predicting material cyber events.

### BACKGROUND

As businesses have become more interconnected due to the ubiquitous use of the internet, new challenges arise which can threaten the security of a business. These threats include an increase in cyber and internet-based attacks. Such attacks can encompass traditional hacking, such as the insertion of viruses within a network, phishing attacks to extract sensitive information, and distributed denial of services attacks. More recent trends have evolved that expose businesses to other types of attacks. These can include ransomware attacks, wherein a malicious entity gains access to a network and prevents the rightful owner from accessing their data, e.g., by encrypting servers and demanding payment for the decryption key.

These events, however, are not limited to intentional malicious actors acting directly on a particular company, e.g., by infecting the target's on-premises servers or databases. Many businesses rely heavily on third-party software and third-party providers, each of which may fail for a variety of reasons which significantly impact customers. Data loss, service outages, and various security vulnerabilities can cause an enormous domino effect from a large provider, down to an end user, when an essential part of a business workflow is affected. For example, Amazon® Web Services (AWS®) provides distributed cloud computing, web services, and storage to hundreds of thousands of businesses across the world. As a large third-party provider, if even part of the AWS® infrastructure suffers from a significant attack, such as an encrypting ransomware attack, many client businesses would be unable to continue normal business operations. Likewise, millions of businesses rely on the Microsoft® Office suite. Should an attacker leverage an exploit in a suite program, every end user would be vulnerable to the attack, often without the direct ability to patch the issue.

As cyber threats continue to become more prevalent, businesses have now begun to account for the possibility of attacks and the costs thereof. Individual businesses must determine their own internal limits of their ability to withstand losses from cyber events (“appetite”). Furthermore, insurance companies now offer cyber insurance products to protect clients, both from internal loss and from liability from loss caused to end users.

Additionally, the Securities and Exchange Commission (SEC) has introduced regulations that mandate companies to report cyber events that result in a material impact.

However, what constitutes “material” varies significantly and is a complex legal issue. Materiality can be defined by several factors, including the duration of the event, the number of records compromised, and the extent of financial loss incurred.

Essentially, materiality is a contextual concept, and its determination requires a case-by-case evaluation. For some organizations, a breach might be considered material if it lasts for an extended period, while for others, it could be the compromise of a substantial number of records or a significant financial loss that deems a cyber event as material.

In navigating these SEC regulations, companies must carefully assess the unique circumstances and potential implications of cyber events to ensure compliance and transparency. Current solutions are limited.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the terms “some embodiments” or “certain embodiments” may be used herein to refer to a single embodiment or multiple embodiments of the disclosure.

Certain embodiments disclosed herein include a computer-implemented method for material cyber event modeling, comprising: generating a cyber event catalog based on a past cyber event, the cyber event catalog including a plurality of cyber events, wherein generating the cyber event catalog further comprises: determining a distribution of all event parameters by extrapolating one or more data points from a past event; and assigning a set of restriction rules, wherein the parameter distribution and the set of restriction rules are used to create events in the event catalog; simulating a cyber event, of the plurality of cyber events included in the cyber event catalog, to predict whether an organization is affected by a simulated cyber event, wherein the organization is an organization selected from a hazard table, and wherein the simulating cyber event simulates malicious activity in the organization; and estimating a damage of the cyber event on the organization by employing a damage function, wherein estimating the damage includes: generating an exceedance probability (EP) curve for the cyber event, for at least one materiality category.

Certain embodiments disclosed herein also include a non-transitory computer readable medium having stored thereon instructions for causing a processing circuitry to execute a process for material cyber event modeling, the process comprising: generating a cyber event catalog based on a past cyber event, the cyber event catalog including a plurality of cyber events, wherein generating the cyber event catalog further comprises: determining a distribution of all event parameters by extrapolating one or more data points from a past event; and assigning a set of restriction rules, wherein the parameter distribution and the set of restriction rules are used to create events in the event catalog; simulating a cyber event, of the plurality of cyber events included in the cyber event catalog, to predict whether an organization is affected by a simulated cyber event, wherein the organization is an organization selected from a hazard table, and wherein the simulating cyber event simulates malicious activity in the organization; and estimating a damage of the cyber event on the organization by employing a damage function, wherein estimating the damage includes: generating an exceedance probability (EP) curve for the cyber event, for at least one materiality category.

In addition, certain embodiments disclosed herein include a system for material cyber event modeling, comprising: a processing circuitry; and a memory, the memory containing instructions that, when executed by the processing circuitry, configure the system to: generate a cyber event catalog based on a past cyber event, the cyber event catalog including a plurality of cyber events, wherein the system is further configured to:
determine a distribution of all event parameters by extrapolating one or more data points from a past event; and assign a set of restriction rules, wherein the parameter distribution and set of restriction rules are used to create events in the event catalog; simulate a cyber event, of the plurality of cyber events included in the cyber event catalog, to predict whether an organization is affected by a simulated cyber event, wherein the organization is an organization selected from a hazard table, and wherein the simulating cyber event simulates malicious activity in the organization; and estimate a damage of the cyber event on the organization by employing a damage function, wherein estimating the damage includes: generating an exceedance probability (EP) curve for the cyber event, for at least one materiality category.

### BRIEF DESCRIPTION OF THE DRAWINGS

The invention may be best understood by reference to the following description taken in conjunction with the accompanying drawing figures in which:

FIG. 1 is a block diagram of potential risk sources and manifestations of those risks which are incorporated in material event modeling, according to an embodiment;

FIG. 2 is an example flowchart illustrating a method of modeling material events, according to an embodiment;

FIG. 3 is a graph showing an EP curve generated, according to an embodiment;

FIG. 4 is a graph showing an EP curve generated, according to an embodiment;

FIG. 5 is a graph showing an EP curve generated, according to an embodiment;

FIG. 6 is a graph showing an EP curve generated, according to an embodiment;

FIG. 7 is a network diagram illustrating a deployment of a system for material event modeling, according to an embodiment; and

FIG. 8 is a block diagram of the materiality analysis system, according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for modeling material events. The method includes employing a modeling framework that addresses events that affect third parties, including service providers that provide off-premises services, such as cloud computing, and technology providers that provide on-premises software used by other companies. The modeling framework includes accounting for physical locations of the clients, data cleansing and grouping, cataloging events, distilling the data to reduce the size of the catalog, and running simulations. Based on the simulations, an estimate of the potential damage caused by a material event is calculated.

The embodiments disclosed herein provide certain improvements in the processing and application of data in the modeling of material events. As described herein, the methods, structures, and the like, included in, and applied by, the various aspects of the disclosed embodiments provide for improvements in modeling task accuracy and granularity. Specifically, as further described herein, the features of the disclosed embodiments provide for enhanced accuracy of modeling outcomes, where such outcomes are applicable to providing loss estimates and related information. Further, the features of the disclosed embodiments provide for the enhanced granularity of modeling processes, providing for improvements to the results of such processes, where such results are applied as described herein.

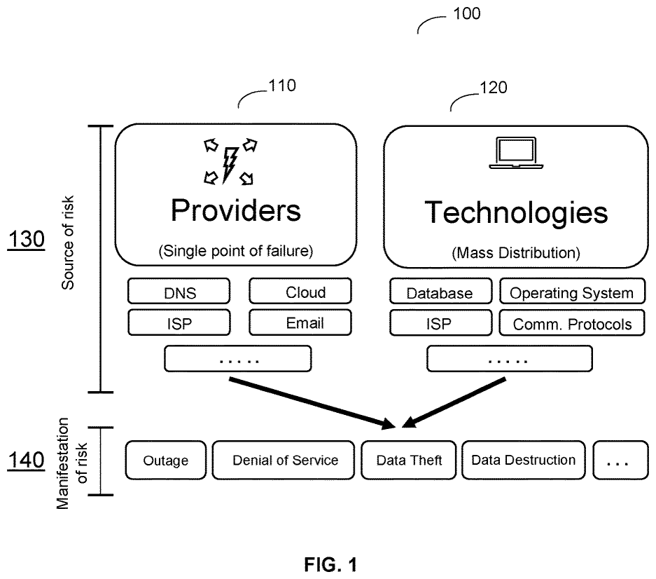

Now, referring to the drawings wherein identical reference numerals denote the same elements throughout the various views, FIG. 1 illustrates an example block diagram 100 of potential risk sources 130 and manifestations 140 of those risks which are incorporated in material event modeling, according to an embodiment. The disclosed embodiment addresses two main risk sources that may trigger a material event: risks that stem from third-party service providers 110, and risks that stem from third-party technology providers 120.

Third-party service providers 110 include shared services, e.g., services provided to multiple businesses or end users, that may be located remotely and accessed over a network, e.g., the internet. These third-party service providers 110 include internet server providers (ISPs), cloud computing or cloud storage providers, DNS providers, cloud email providers, data analysis providers, and the like. The services offered rely on hardware and software that are not based on the premises of the user of said services. For example, a DNS or email server may be operated from a remote location or distributed from multiple remote locations controlled by the provider. Third-party service providers 110 are vulnerable to a single point of failure, as a successful attack at one location, for example, a central server location of a shared DNS server providing DNS services to hundreds or thousands of clients, will negatively affect all clients that rely on that shared server immediately.

Third party technology providers 120 include providers of technologies which are created by a third party and distributed to many clients, such as software authored by a single entity but licensed to be used by many clients. Examples include operating systems, such as Microsoft® Windows®, database software, third-party software libraries, such as encryption libraries employed in web servers or point of sale devices, common protocols employed by many end users, and the like. Here, a flaw found in the software itself creates vulnerabilities in each system running the software, namely each individual client, rather than in a single central location.

A cyber event occurs when a service or technology is breached or attacked, such that clients are affected. In order to successfully determine the likelihood of a cyber event, a catalog is formed that includes various potential cyber events that are classified into multiple subclassifications. The subclassifications can then be analyzed and employed in simulations described further below. For third party service provider 110 events, the subclassifications include at least a provider type, and an impact type. The provider type includes categories of services, such as DNS, email, cloud computing and the like. An impact type defines how a business is affected by an event and the potential damage caused. This includes data loss, data theft, outages, and the like. In an embodiment, the catalog includes the provider types and impact types of past events.

For third party technology providers 120, the sub-classifications include the type of technology, such as databases, web servers, software libraries, and the like, as well as the impact type noted above, e.g., data loss, data theft, outages, and so on.

An additional subclassification is an event scope which includes information related to the geographical location of the event. Such a geographical location subclassification differs from a corresponding classification of a natural event in that, rather than being centered around where the event occurs, the location of a cyber event can be spread worldwide. For example, AWS® runs on servers located in many countries around the world. If a server in Virginia, USA, which serves clients in western Europe or southeast Asia, is successfully attacked, the clients'location is the relevant affected area, rather than the location of the server. Similarly, hardware built and sold by a U.S. company may be used by international businesses across the globe. Thus, the location of those affected by the attack must be determined and categorized for proper damage estimation, regardless of the location of the physical server.

The statistical distribution may be based on extrapolated data from past events. In an embodiment, this distribution is determined based on data collected from various users, where the data includes mapping service and technology providers to physical locations of its users. If an AWS® server in Virginia is configured to serve clients in Japan, a breach in the Virginia server will be associated with risk for clients in Japan.

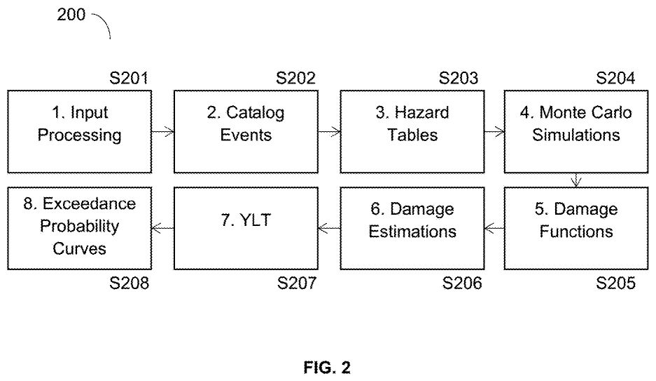

FIG. 2 is an example flowchart 200 illustrating a method of modeling material events, according to an embodiment.

At S201, low-resolution cyber event data is received and processed to improve the data quality. The processing includes a number of steps to ensure that the data is prepared for the simulation step discussed below.

In an embodiment, execution of S201 includes a data cleansing, first performed for the supplied companies'data, where the data itself is modified and formatted for use in modeling. This cleansing includes converting data to a preferred format. For example, if a model is designed to simulate costs based on U.S. dollars, and the input data is presented in Euros, a currency conversion is applied to the data to ensure it is uniform.

Next, S201 may further include data omitting, where irrelevant data may be removed. Such omitting may include, for example, removing any data from certain countries or jurisdictions which are determined to be excluded from the simulation.

The final stage in the execution of S201 may include data augmentation, where data which is not sufficiently accurate is enhanced by retrieving additional data necessary to increase the data's accuracy. For example, if a model requires granular location details about a client, but only the country of residence is provided in the input data, the missing data may be determined. Thus, if a set of clients only includes a location specifying the United States, the relevant states of residence may be determined, e.g., based on available zip code information, and used to augment the original data.

Data received and processed at S201 may be grouped according to one or more input groups, such input groups including, as examples and without limitation, industry, country, and coverage type.

At S202, an event catalog is created. The event catalog is a collection of one or more recorded cyber events, predicted cyber events, or any combination thereof. Further, the event catalog may be configured to include, for each cyber event record included therein, one or more descriptors, such descriptors including, without limitation, technologies affected by a specific cyber event, service providers affected by a specific cyber event, and the like, as well as various combinations thereof. As may be applicable to the embodiments described herein, a technology, as may be included as a descriptor of an event catalog record, is a product, service, application, or other suite, package, toolkit, or the like, which an organization may implement or include in one or more products or operations. Examples of technologies include, without limitation, cybersecurity software, office productivity software, database-management packages, and the like. Further, as may be applicable to the embodiments disclosed herein, a service provider, as may be included as a descriptor in an event catalog record, is an organization, company, or other provider of services, technologies, and the like. As an example, where a given technology is the Microsoft® Office® suite, which may be licensed by a client organization on a per-user subscription basis, the relevant service provider may be Microsoft®. In an example embodiment, the event catalog includes a list of potential material events. The creation of the event catalog includes several steps.

In an embodiment, S202 includes determination of a distribution of all event parameters and assignment of a set of restriction rules. The parameter distribution and restriction rules are used to create the events in the event catalog.

In order to discover the underlying distribution of all event parameters, data from past events is extrapolated. In an embodiment, this step includes collecting data from multiple databases, such as CVE data and open-source monitoring dashboards. In another embodiment, active exploitation databases are accessed and threat intelligence data collection is performed. Such access and collection may be used to extract exploit kits used by attackers, as well as details identifying targeted technologies.

As an example, to calculate the distribution of the duration of a provider-type event, i.e., the amount of time in which the event took place, the durations of all past provider-type events are examined and fit into a distribution. For each parameter, e.g., industry, location, coverage type, and the like, many possible distributions are examined and are combined using Bayesian inference. Because the method relies on statistics, a sufficiently large sample size may be required to ensure accurate results. In an embodiment, determining the distribution may include using validation and test sets as control groups.

In an embodiment, a set of restriction rules is employed, where the set of restriction rules restrict the way in which synthetic events are created. The restriction rules are based on current cyber event knowledge, historical events, and cyber academic research. For example, for a cyber event including exploitation of a vulnerability in a database product that is only sold and operated in China, the event location will be limited to China.

Using the parameter distribution and restriction rules discussed above, a large set of synthetic events is generated for the creation of a full event catalog. For example, an event catalog may include 100,000 different synthetic events. The generation of synthetic events is based on the parameter distribution calculated in the previous step. Therefore, the probability of an event appearing in the event catalog is related to the likelihood of the event occurring. Based on the statistical distribution, a large portion of the event catalog may include moderately-severe events, as the more severe an event is, the less likely the event is to appear in the catalog.

It should be noted that there may often be an approximately equal number of provider and technology event types in the catalog. For example, for an event catalog with 100,000 entries, the catalog may include 50,000 technology event types and 50,000 provider event types.

In an embodiment, using a K-means algorithm, the full event catalog is distilled, or “boiled-down,” to a smaller subset, e.g., of 25,000 events, in order to reduce the number of similar events within the event catalog. Such a number (e.g., 25,000) is derived from an average number of events that occur in a year period. The usage of a yearly average number of events, that may also be used as the ‘λ’ parameter of a Poisson distribution in the Monte Carlo simulation discussed below, assures that the size of the boiled-down catalog is sufficiently large and contains enough events for a useful Monte Carlo simulation.

In an example embodiment, the boil-down process may include clustering together events that share similar parameters and adjusting the rate of the clustered events accordingly. After clustering, all events in the event catalog are examined to ensure that they are all possible, i.e., have a sufficient likelihood of occurring in practice. This is required to ensure that events may have a significant effect in the event catalog.

In an embodiment, after the boil-down process, past events are employed as a control measure to ensure that events that have already happened appear in the event catalog. This may be performed by checking whether the frequency of each parameter matches the historic catalog frequency.

Each event within the “boiled-down event catalog” (i.e., the outcome of the boil-down process) is assigned an event ID that is constant and used each time the model is run. The event IDs only change when the model is updated to accommodate new data regarding new events, threats, and changes happening in the cyber and IT ecosystem. These updates are necessary to maintain a realistic and plausible set of events within the catalog.

It should be noted that, at this point of the process, an equal number of provider and technology events remain in the catalog, e.g., 12,500 events for each event type.

At S203, a hazard table is created to estimate exposure to a cyber event. The hazard table is a summary representation of assets (services and technologies) that are used by the companies. In an embodiment, the hazard table is created by actively mapping, to the security controls, the assets used by every insured company. It should be noted that a table is only one example, and that other data structures may be applicable.

It should be understood that S202 and S203 may be executed in any order, including simultaneously, without loss of generality or departure from the scope of the disclosure.

At S204, a Monte Carlo simulation is run on the boiled-down event catalog using the contents of one or more hazard tables as parameters. The execution of the Monte Carlo simulation at S204 provides, for each year modeled, an assessment of which companies, of those included in the one or more hazard tables, will be affected by cyber events, such as the cyber events described in the boiled-down event catalog. In an example embodiment, a standard Monte Carlo simulation of 10,000 years is run based on the events in the boiled down catalog.

For each simulated year, a number of events simulated in that year is sampled from a Poisson distribution with a ‘λ’ parameter. As noted above, the ‘λ’ parameter represents the average number of events that happen in a year, where the ‘λ’ parameter is determined based on an analysis of past event data. Thus, the probability that each event is chosen is the event's rate multiplied by the ‘λ’ parameter.

After determining the number of events in a simulated year, events are chosen from the boiled-down event catalog for the simulation. Each selected event is categorized as either a provider-type event or a technology-type event. This is performed by sampling using a parameter that defines the ratio between the two types of events. While the ratio may start out as 1:1, the ratio parameter can change often when incorporating new data. By using this parameter, the ratio can be frequently updated without having to change the entire event catalog.

At S205, damage functions are employed to estimate the potential damage of cyber events included within the catalog. The damage function's input is the local intensity of an event, and the function yields a damage factor. The local intensity parameter generation is further explained below. The damage factor indicates the estimated damaged percentage of the exposed value. A damage factor of 1 means a total loss of the exposed value, and a damage factor of 0 means the cyber event has had no effect.

A damage function is based on two or more parameters including, as examples and without limitation, industry, event type, coverage type, business size, business industry, business location, and the like. Each parameter has a direct relation to the proportion of damage caused. For example, a cyber event that caused a cloud outage will likely affect an e-commerce company more than the event will affect a law firm, as the cloud functions will likely tie more closely to the core business of the e-commerce company. Thus, such an event may trigger business interruption coverage for the e-commerce company, while failing to do so for the law firm.

It should be noted, however, that while, according to the example, the industry type parameter is the most relevant parameter in the above example, the damage function will likely also be affected by the other parameters, namely the event type, location, and coverage type. A change in any of these parameters will also change the damage estimation and, therefore, all parameters are needed in order to define the damage function. In an embodiment, historic incident data with financial impact, insurance claim data, academic research, and the like, are also used to determine the damage function value.

At S206, potential damages from cyber events are estimated. When estimating damage, the input groups from S201 are used, namely industry, country, and coverage type. The impact that each cyber event has on each group is determined based on all of the events in the catalog. The damage of each event on each group, as a whole, is then determined. To calculate the event damage estimation, a local intensity factor is determined for each event. The local intensity of an event combines the intensity of the event and the amount of exposure of a portfolio entity, e.g., a single company.

The intensity of an event is derived from the event parameters. For example, an event with a long duration and a large scope will have a higher intensity than an event with a small scope and short duration.

The exposure of a portfolio to the event is derived from the hazard tables. For each company in the portfolio, the corresponding hazard data is used. The intensity and the exposure are then used to calculate the local intensity, and the damage function is used to determine the damage factor.

As an example, a damage factor may reflect the effect of an AWS outage in an Austrian data center on a company that uses that data center. If the intensity of the event is determined to be 0.5 and the exposure of the company for an AWS Austrian data center outage is 0.3, the local intensity is calculated by multiplying the exposure factor by the intensity factor. Thus:

$$exposure factor \times intensity factor = local intensity ( 0.3 \times 0.5 = 0.15 )$$

After calculating the local intensity, the relevant damage function is used to calculate the damage factor. In the current example, the relevant damage function yields a damage factor of 0.5 for a local intensity of 0.15. The damage factor can then be used to calculate the ground-up loss.

At S207, a yearly loss table (YLT) is created based on the damage estimations. The YLT is a table that contains all of the events from the Monte Carlo simulation, combined with the damage estimation per company for each event, and a brief description of the event, including metadata about the event. For example, a YLT may include a row indicating that, in year 3, a cloud storage vulnerability may be discovered, with an associated damage estimate of $940 million.

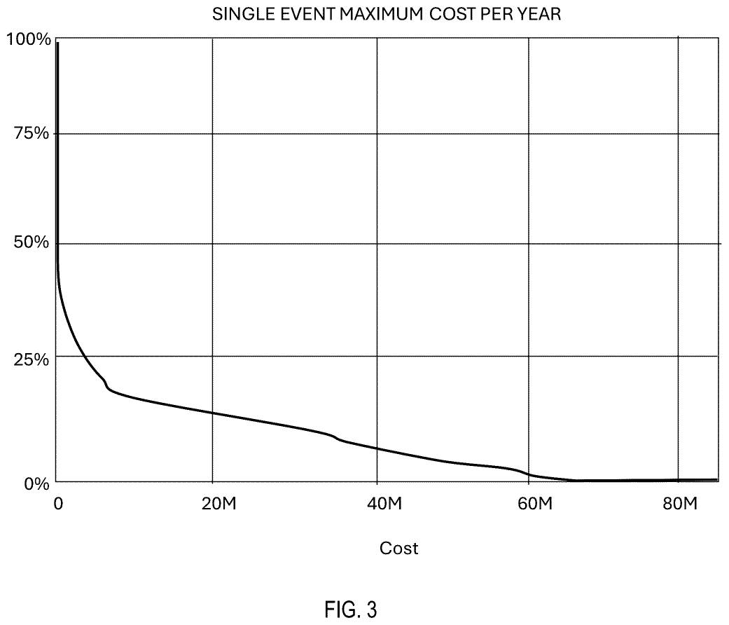

At S208, exceedance probability (EP) curves are determined. The determination of EP curves includes reducing the YLT by calculating an annual exceedance probability (AEP) by summing the damages of each year. This reduced table is used to plot the EP curve. An example graph showing the EP curve is described with respect to FIG. 3, wherein FIG. 3 is a graph showing the EP curve generated, according to an embodiment.

The information from the EP curves can be used to determine the probability of material events. Materiality can be defined with respect to one or more materiality categories. Examples of materiality categories include the following: (1) material financial loss; (2) amount of records compromised; or (3) cyber event duration. The method and system described herein provides a tool for risk management based on any one of these categories, or any combination thereof.

As a preliminary step, materiality thresholds are set or inputted into the system. These thresholds constitute the organization's “appetite” for risk (expressed on an annual basis). A predicted risk of average annual loss may be equal to, greater than, or less than the appetite. Each of these situations has a different implication for corrective action. For example, if the predicted every general loss is greater than the risk appetite. This is an indicator that additional security spending is necessary or additional insurance coverage should be purchased.

The system is capable of generating usable output from any arbitrary threshold. However, it may be programmed to recommend or suggest thresholds based on reasonable values. Sources of recommendations can include, for example industry standards and/or best practices.

A default threshold for a material financial loss is set. This value may be determined as a percentage of the company's annual revenue. In one example, the percentage may be 1%. An example where the company has an annual revenue of $4.49 billion, the material financial loss default threshold would be $44.9 million. Accordingly, an event exceeding a loss of $44.9 million would be considered material, while an event with a lower loss would not be considered material.

A default threshold for a material amount of records is set. This value is set at a proportion of the records stored together by the company. In one example, the percentage may be 10%. In an example where the company stores 110,000 records, the material number of records would be 11,000. Accordingly, an event exceeding compromise of 11,000 records would be considered material, while a lower number of compromised records would not be considered material.

A default threshold for a material event duration is set. This may be determined based on values derived from a) the company's response to relevant questions; b) values attributed to the company based on its firmographic profile; and/or c) values derived from its technographic profile. In one example, a default threshold may be 24 hours. Accordingly, an event exceeding 24 hours in duration would be considered material, while an event shorter than that would not be considered material.

Once these thresholds are determined, the system can refer to the EP curve for the appropriate materiality category. A visualization can be generated including the EP curve, along with information about the relevant threshold. The visualization may also include other plots of interest to the company being modeled, such as sub-limits of insurance, early warning thresholds, and the like.

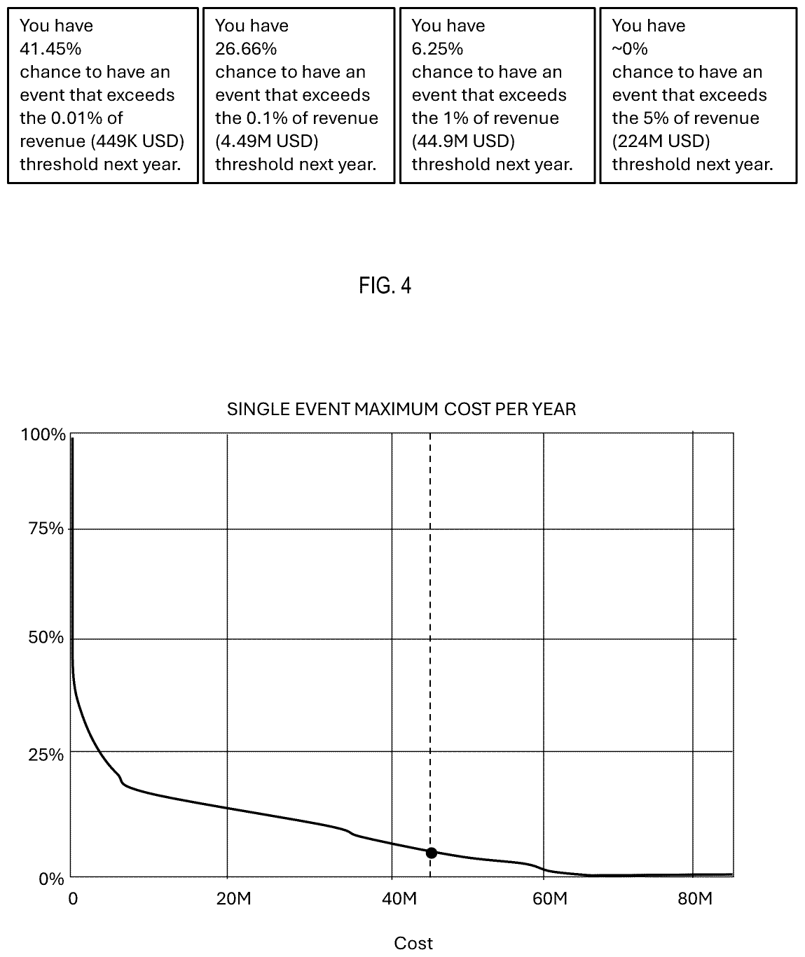

FIG. 4 is a visualization example of a cyber materiality report including an EP chart showing probability of an event correlated to the estimated financial loss. The chart includes a vertical line indicating the example threshold of 1% of sales. Determining a Y-axis intersection from the underlying chart data shows a 6.25% chance of incurring an event that exceeds this threshold. The chart includes a visual representation of this probability. The visualization also includes additional data for other potential thresholds (namely 0.01%, 0.1%, and 5%).

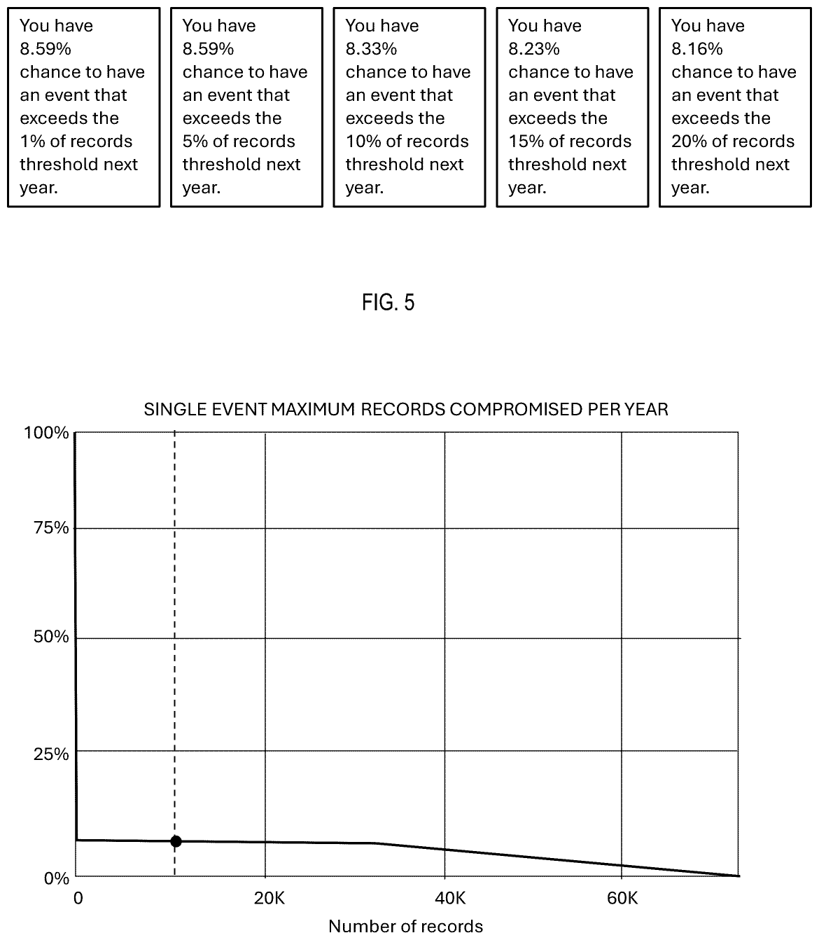

FIG. 5 is a visualization example of a cyber materiality report including an EP chart showing probability of an event correlated to the estimated number of records compromised. The chart includes a vertical line indicating the example threshold of 11,000 records (10% of the total records). Determining a Y-axis intersection from the underlying chart data shows an 8.33% chance of incurring an event that exceeds this threshold. The chart includes a visual representation of this probability. The visualization also includes additional data for other potential thresholds (namely 1% of records, 5% records, 15% of records, and 20% of records).

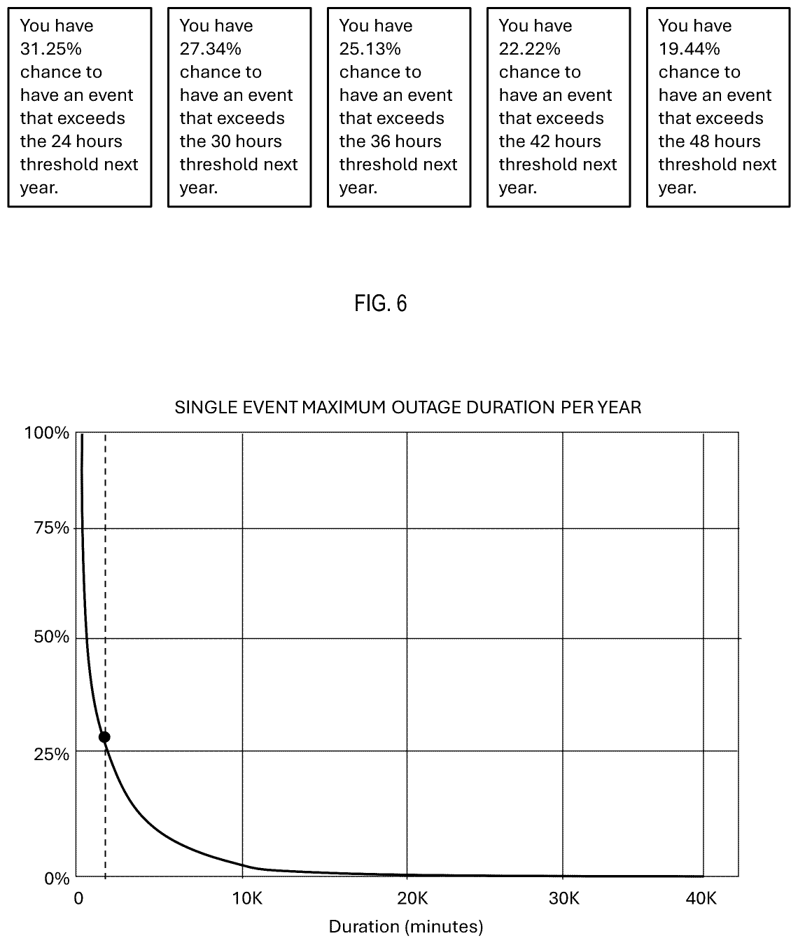

FIG. 6 is a visualization example of a cyber materiality report including an EP chart showing probability of an event correlated to the outage duration. The chart includes a vertical line indicating the example threshold of 24 hours. Determining a Y-axis intersection from the underlying chart data shows a 31.25% chance of incurring an event that exceeds this threshold. The chart includes a visual representation of this probability. The visualization also includes additional data for other potential thresholds (namely 30 hours, 36 hours, 42 hours, and 48hours).

The method and system described herein has certain advantages over the prior art. The cyber materiality report allows a user to determine which cyber risks are likely to meet materiality thresholds, rendering them suitable and applicable for SEC annual report disclosures (e.g., 10-K, 20-F), and facilitates the selection of a risk appetite threshold or thresholds for internal risk governance.

It also creates a data-driven framework for quickly aligning incidents to risk to know if a material disclosure is advisable within the given 4-day period (8-K).

It allows the user to confidently communicate the state of the organization's cyber posture and what the cyber program recommends qualifies as preliminarily material to appropriate personnel within the organization (legal counsel, board of directors).

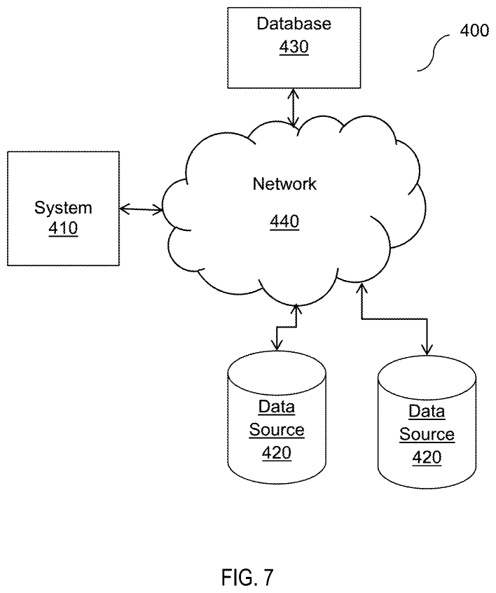

FIG. 7 shows an example network diagram 400 illustrating a deployment of a materiality analysis system 410 for material event modeling, according to an embodiment.

The diagram 400 depicts the materiality analysis system 410, a plurality of data sources 420, and a database 430 communicating over a network 440. The network 440 may be, but is not limited to, a wireless, cellular, or wired network, a local area network (LAN), a wide area network (WAN), a metro area network (MAN), the Internet, the world wide web (WWW), a network similar to those described, and any combination thereof.

In an example embodiment, the data sources 420 provide the data used in past event extrapolation. The data sources 420 may include Common Vulnerabilities and Exposures (CVE) databases, open-source monitoring dashboards, proprietary databases, active exploitation databases, and threat intelligence data sources.

The materiality analysis system 410 is configured to perform various embodiments disclosed herein. Specifically, the system 410 is configured to implement processes for material event modeling as discussed with reference to FIG. 2.

The materiality analysis system 410 may be implemented as a physical machine, a virtual machine, or a combination thereof. A block diagram of an example depicting a physical machine implementation is discussed below with reference to FIG. 5. A virtual machine may be any virtual software entity, such as a software container, a micro service, a hypervisor, and the like.

The database 430 may store the event catalogs, the hazard tables, the exceedance probability curves and data, or any other report that can be generated according to the disclosed embodiments. The database 430 may be a relational database or a NoSQL type of database such as, but not limited to, MongoDB. Examples of relational databases may include, but are not limited to, Oracle®, Sybase®, Microsoft SQL Server®, Access®, Ingres®, and the like. In an embodiment, the database 430 may be a plurality of logical entities residing in the same physical structure.

In an embodiment, the optional database 430 may be included in the system 410. In an alternate embodiment, the optional data store may be realized as separate components connected directly with the network 440, with the system 410, or both.

It should be noted that the embodiments disclosed herein are not limited to the specific architecture illustrated in FIG. 7, and that other architectures may be equally used without departing from the scope of the disclosed embodiments. Specifically, the materiality analysis system 410 may reside in a cloud computing platform, a datacenter, and the like. The cloud computing platform may be a private cloud, a public cloud, a hybrid cloud, and the like.

Moreover, in an embodiment, there may be a plurality of systems operating as a distributed system. Further, the database 430 may be distributed as well. In some implementations, the materiality analysis system 410 may be an internal component or instance of any of the data sources 420. In an embodiment, the materiality analysis system 410 may include one or more data stores.

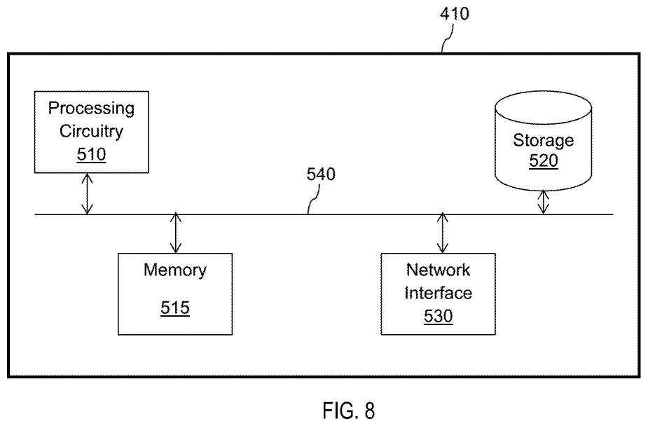

FIG. 8 shows an example block diagram of the materiality analysis system 410, according to an embodiment. The materiality analysis system 410 includes a processing circuitry 510 coupled to a memory 515, a storage 520, and a network interface 530. In an embodiment, the components of the system 410 may be communicatively connected via a bus 540, e.g., PCIe or other high-speed data bus.

The processing circuitry 510 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, graphics processing units (GPUs), tensor processing units (TPUs), general-purpose microprocessors, microcontrollers, and digital signal processors (DSPs), and the like, or any other hardware logic components that can perform calculations or other manipulations of information.

The memory 515 may be volatile (e.g., RAM, etc.), non-volatile (e.g., ROM, flash memory, etc.), or a combination thereof. In one configuration, computer readable instructions to implement one or more embodiments disclosed herein may be stored in the storage 520.

In another embodiment, the memory 515 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 510 to perform the various processes described herein.

The storage 520 may be magnetic storage, optical storage, and the like, and may be realized, for example, as flash memory or other memory technology, CD-ROM, Digital Versatile Disks (DVDs), or any other medium which can be used to store the desired information.

The network interface 530 allows the system 410 to communicate with the at least one various data sources or databases. It should be understood that the embodiments described herein are not limited to the specific architecture illustrated in FIG. 5, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A computer-implemented method for material cyber event modeling, comprising:
generating a cyber event catalog based on a past cyber event, the cyber event catalog including a plurality of cyber events, wherein generating the cyber event catalog further comprises:
determining a distribution of all event parameters by extrapolating one or more data points from a past event; and
assigning a set of restriction rules, wherein the parameter distribution and the set of restriction rules are used to create events in the event catalog;
simulating a cyber event, of the plurality of cyber events included in the cyber event catalog, to predict whether an organization is affected by a simulated cyber event, wherein the organization is an organization selected from a hazard table, and wherein the simulating cyber event simulates malicious activity in the organization; and
estimating a damage of the cyber event on the organization by employing a damage function, wherein estimating the damage includes:
generating an exceedance probability (EP) curve for the cyber event, for at least one materiality category.

2. The method of claim 1, further comprising generating a visualization of the EP curve.

3. The method of claim 1, further comprising:
setting a threshold damage value for the at least one materiality category;
referencing the EP curve, using the threshold value; and
based on the EP curve, determining a probability of the cyber event exceeding the threshold damage value.

4. The method of claim 1, wherein the at least one materiality category is the financial cost of a single cyber event.

5. The method of claim 1, wherein the at least one materiality category is a maximum number of data records compromised.

6. The method of claim 1, wherein the at least one materiality category is a maximum duration of the cyber event.

7. The method of claim 1, wherein simulating the cyber event further comprises:
simulating the cyber event via a Monte Carlo simulation.

8. The method of claim 1, wherein the event catalog includes a plurality of potential material events.

9. The method of claim 1, wherein determining the distribution of all event parameters further comprises collecting data from at least one of: a CVE database, an open-source monitoring dashboard, and a proprietary database.

10. The method of claim 1, wherein determining the distribution of all event parameters further comprises:
accessing an active exploitation database; and
collecting threat intelligence data.

11. The method of claim 1, wherein determining the distribution of all event parameters further comprises using validation and test sets as control groups.

12. The method of claim 1, wherein determining the distribution of all event parameters further comprises using a K-means algorithm to distill a full event catalog to a smaller subset.

13. The method of claim 1, wherein generating the hazard table further comprises:
actively mapping, to one or more security controls of a plurality of security controls, one or more assets used by one or more companies.

14. The method of claim 13, wherein generating one or the EP further comprises:
calculating an annual exceedance probability (AEP), wherein the AEP is calculated by summing damages of each year.

15. A non-transitory computer readable medium having stored thereon instructions for causing a processing circuitry to execute a process for material cyber event modeling, the process comprising:
generating a cyber event catalog based on a past cyber event, the cyber event catalog including a plurality of cyber events, wherein generating the cyber event catalog further comprises:
determining a distribution of all event parameters by extrapolating one or more data points from a past event; and
assigning a set of restriction rules, wherein the parameter distribution and the set of restriction rules are used to create events in the event catalog;
simulating a cyber event, of the plurality of cyber events included in the cyber event catalog, to predict whether an organization is affected by a simulated cyber event, wherein the organization is an organization selected from a hazard table, and wherein the simulating cyber event simulates malicious activity in the organization; and
estimating a damage of the cyber event on the organization by employing a damage function, wherein estimating the damage includes:
generating an exceedance probability (EP) curve for the cyber event, for at least one materiality category.

16. A system for material cyber event modeling, comprising:
a processing circuitry; and
a memory, the memory containing instructions that, when executed by the processing circuitry, configure the system to:
generate a cyber event catalog based on a past cyber event, the cyber event catalog including a plurality of cyber events, wherein the system is further configured to:
determine a distribution of all event parameters by extrapolating one or more data points from a past event; and
assign a set of restriction rules, wherein the parameter distribution and set of restriction rules are used to create events in the event catalog;
simulate a cyber event, of the plurality of cyber events included in the cyber event catalog, to predict whether an organization is affected by a simulated cyber event, wherein the organization is an organization selected from a hazard table, and wherein the simulating cyber event simulates malicious activity in the organization; and
estimate a damage of the cyber event on the organization by employing a damage function, wherein estimating the damage includes:
generating an exceedance probability (EP) curve for the cyber event, for at least one materiality category.

17. The system of claim 16, wherein the system is further configured to generate a visualization of the EP curve.

18. The system of claim 16, wherein the system is further configured to:
setting a threshold damage value for the at least one materiality category;
referencing the EP curve, using the threshold value; and
based on the EP curve, determining a probability of the cyber event exceeding the threshold damage value.

19. The system of claim 16, wherein the at least one materiality category is the financial cost of a single cyber event.

20. The system of claim 16, wherein the at least one materiality category is a maximum number of data records compromised.

21. The system of claim 16, wherein the at least one materiality category is a maximum number of data records compromised.

22. The system of claim 16, wherein the system is further configured to:
simulate the cyber event via a Monte Carlo simulation.

23. The system of claim 16, wherein the event catalog includes a plurality of potential material events.

24. The system of claim 16, wherein the system is further configured to:
collect data from at least one of: a CVE database, and an open-source monitoring dashboard.

25. The system of claim 16, wherein the system is further configured to:
access an active exploitation database; and
collect threat intelligence data.

26. The system of claim 16, wherein the system is further configured to:
use validation and test sets as control groups.

27. The system of claim 16, wherein the system is further configured to:
use a K-means algorithm to distill a full event catalog to a smaller subset.

28. The system of claim 16, wherein the system is further configured to:
actively map, to one or more security controls of a plurality of security controls, one or more assets used by one or more companies.

29. The system of claim 16, wherein the system is further configured to calculate an annual exceedance probability (AEP), wherein the AEP is calculated by summing the damages of each year.
